(19) United States
(12) Patent Application Publication
(10) Pub. No.: US 2019/0347684 A1
(43) Pub. Date: Nov. 14, 2019

(54) METHOD FOR MANAGING MEDIA CONTENT FOR POI AND SYSTEM THEREOF

(71) Applicant: Framy Inc., Grand Cayman (KY)

(72) Inventor: Yu-Hsien Li, TAIPEI CITY (TW)

(21) Appl. No.: 16/179,991

(22) Filed: Nov. 4, 2018

(30) Foreign Application Priority Data
May 11, 2018 (TW) 107116153

(51) Int. Cl. G06Q 30/02; G06F 17/30; G06Q 50/00

(52) U.S. Cl. CPC G06Q 30/0214; G06Q 30/0276; G06Q 50/01; G06F 17/30241

(57) ABSTRACT

A method for managing media content for POI and a system thereof are provided. An advertiser sets up an advertisement relating to a POI and a reward criterion in the system. A server of the system queries a database according to positioning data generated by a user device so as to acquire one or more POIs. The POIs may include one or more POIs with reward. The system then provides information relating to the POI with reward to the user based on the advertiser's requirement. The user proceeds to the POI and creates a media content according to the reward criterion. The user can shoot a video of the POI and upload it to the server. The system provides a reward to the user when the server confirms that the media content meets the reward criterion. A link for the media content is created with respect to the POI.

### CROSS-REFERENCE TO RELATED PATENT APPLICATION

This application claims the benefit of priority to Taiwan Patent Application No. 107116153, filed on May 11, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The disclosure is generally related to a method and a system for managing media content, and in particular to a management method and system for people-generated media content at a Point Of Interest (POI), which achieves the effect of advertisement.

### BACKGROUND OF THE DISCLOSURE

General social media not only provides services for social activities, but has also replaced the traditional media to become a content center, a news center or a shopping platform. This has attracted advertisers to advertise their products or services through social media since the social media can effectively obtain its users' personal data such as their genders, ages, interests and professions through big-data analysis. The social media allows the advertiser to set up the preferred marketing audience. For example, if a product is designed for women, the advertiser of the product may set up its marketing audience as women; if an electronic product is provided, the advertiser may set up a specific age range of users to be the targets for marketing; and mothers with children can also be the marketing targets when infant products are advertised.

In the social media and other types of media such as web portals and blogs, the conventional advertisement thereon shows the company's contact information such as an address, a website URL, a social media user name, a telephone number or an electronic mail that allows the social media users who are interested in the advertisement to click for obtaining further information relating to the company.

However, despite that it may be possible for advertisers to learn the number of visitors directed to their websites from relevant advertisements, it is not easy for the advertiser owning a physical store to grasp which of their customers were led to their store through said advertisements. Therefore, it is not easy to evaluate the advertising performance. The advertiser can only constantly spend money on marketing despite the uncertainty of the advertisement performance.

Reference is made to FIG. 1, which is a schematic diagram showing a conventional scenario of submitting an advertisement to social media.

In the diagram, a user 10 browses a content of a social network site using a user device 12 that executes a social community program 120. The content may also be one posted on a blog, a web page, or a search result obtained by a search engine. An advertisement 122 is embedded in the content. The advertisement 122 is generally a content that attracts the user 10 to click for obtaining further information. The advertisement 122 can be used to direct the user 10 to a web page 14 or an address and contact information of the store 16. An ultimate goal of the advertisement 122 would be to direct the users to come to the physical store for purchasing products.

Aside from using inquiries or questionnaires, it is difficult for the advertiser to know which of the visiting customers in the physical store 16 have come through the advertisement 122 submitted to the social community program.

### SUMMARY OF THE DISCLOSURE

In response to the above-referenced technical inadequacies, the present disclosure provides a method and a system for managing media content for Point of Interest (POI).

An aspect of the invention of the disclosure is to allow an advertiser to submit an advertisement to the system for managing media content for POI and to set up the advertisement content. The content may be an address and introduction of a physical store or include a criterion for rewarding users. A proportion and a criterion for rewarding can be set up in the management system. Information of a point of interest with reward can be messaged to the users. The users can arrive at the store for creating a media content according to a requirement of the system and the advertiser. The media content can be any combination of text, voice, picture and video, and a positioning data can also be carried with the media content. The media content is then uploaded to a server of the system for managing media content for POI. The system can provide a reward to the user when it determines that the uploaded content is in compliance with the reward criterion.

Thus, the management method and system effectively attract people to arrive at the store due to the advertisement submitted by the owner or advertiser, and the advertiser can see the actual advertising performance. This aspect can further attract the people to purchase in the store for gaining more commercial benefits. The store owner can accordingly offer discount and the reward criterion.

According to one embodiment of the disclosure, the method for managing media content of a POI is operated in a server of the management system. When the server receives positioning data generated by a user device via a network, a software program operated in the server conducts a query of a database. One or more POIs corresponding to the positioning data can be obtained. If any POI has a reward criterion, the server provides information of the POI with reward through the user device. For example, the server can actively provide positioning information of the POI.

After that, the user brings the user device to arrive at the position of the store associated with the advertisement, and creates a media content such as a video relating to the store. When the media content is uploaded to the server, the software program running in the server verifies whether or not the position where the media content is created matches the reward criterion. If the media content matches the criterion, the system provides a reward to the user. It should be noted that the reward is a portion of a fee submitted by the advertiser.

Further, in the server, a media content link is applied to the media content for associating with the point of interest. The media content link allows other users to see the media content when they approach the store, i.e. the point of interest.

Further, the user can search a geographic range using an electronic map on the user device. A positioning data correlated with the geographic range is generated. The positioning data is uploaded to the server for comparison, and one or more POIs associated with the geographic range can be obtained. The system can also provide the information of the POI(s) with reward(s). The information can attract the users to proceed to the POI for gaining the reward.

In another aspect of the disclosure, a positioning circuit of a user device generates positioning data when the user device is at a location. The positioning data is uploaded to the server of the system for managing media content for POI. After querying a database, if any POI with reward corresponding to the positioning data is found in the database, the system proactively transmits an invitation message to the user device that generates the positioning data. The invitation message includes the position and reward criterion relating to the POI.

The user-end program provided by the management system is performed for the user to browse the information of POIs. If any POI with reward is found, an option is provided for the user to select one of the POIs. The user can obtain information provided by the user-end program. The option allows the user to decide whether or not he wants to proceed to the POI to gain the reward.

Further, the advertiser sets up an advertisement by an advertisement setting page provided by the server so as to create a POI with reward. The information of the POI includes a POI name, a POI location, an advertisement time, a target user condition and reward criterion.

In one embodiment of the system for managing media content for POI, a server and a database are provided. The server utilizes one or more processors to perform the method for managing media content for POI. A database is used to record POIs set up by a plurality of advertisers. The POI data includes information of POI, position of POI and a related reward criterion.

In one aspect, the present disclosure provides a method for managing media content for POI, operated in a server of a system for managing media content for POI. The method includes: the server receiving a positioning data generated by a user device via a network; in the server, querying a database to obtain one or more POIs corresponding to the positioning data; providing information including a POI location of each POI with reward by the user device if one or more POIs with reward corresponding to the positioning data is found; the server receiving media content from the user device; and providing a reward if the media content is verified to match a reward criterion based on a location where the media content has been created.

In one aspect, the present disclosure provides a system for managing media content for POI. The system includes a server and a database. The server by one or more processors of the server, performs a method for managing media content for POI. The database, associated with the server, records a plurality of POIs set up by a plurality of advertisers, and a POI name, a POI location, an advertising time, a target user condition and a reward criterion with respect to each of the POIs. The management method includes: receiving a positioning data generated by a user device via a network; querying the database for obtaining one or more POIs corresponding to the positioning data; providing information including a POI location of each POI with reward by the user device if one or more POIs with reward corresponding to the positioning data is found; receiving media content from the user device; and providing a reward if the media content is verified to match a reward criterion based on a location where the media content has been created.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 shows a schematic diagram depicting a conventional circumstance of submitting an advertisement via a social media;

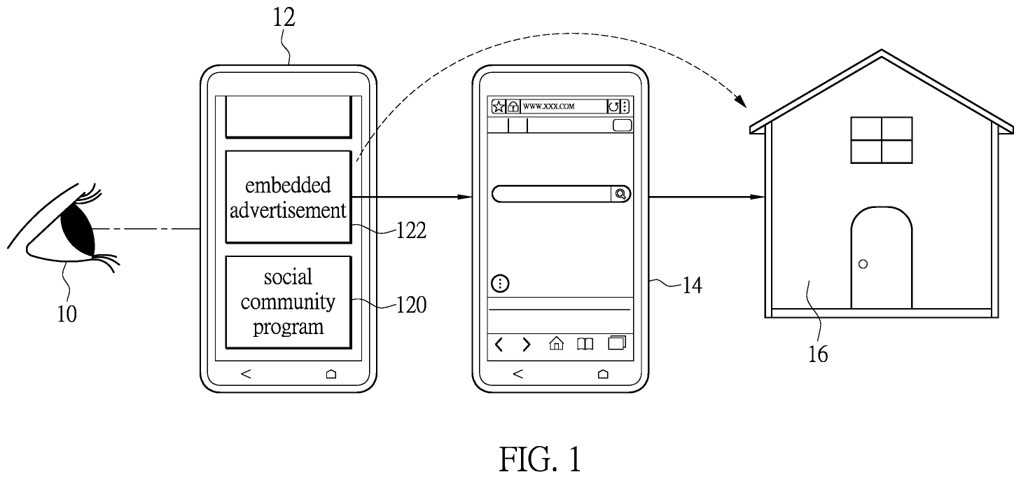

FIG. 2 shows a schematic diagram depicting a system framework of a system for managing media content for POI according to one embodiment of the disclosure;

FIG. 3A to FIG. 3B show schematic diagrams of user interfaces that allow an advertiser to set up advertisement according to one embodiment of the disclosure;

FIG. 4 shows a flow chart describing a method for managing media content for POI according to one embodiment of the disclosure;

FIG. 5 shows a flow chart describing the method for managing media content for POI according to one embodiment of the disclosure;

FIG. 6 shows a flow chart describing the method for managing media content for POI according to one further embodiment of the disclosure;

FIG. 7 shows a flow chart describing the method for managing media content for POI according to one embodiment of the disclosure;

FIG. 8 shows a flow chart describing the method for managing media content for POI according to one other embodiment of the disclosure;

FIG. 9A to FIG. 9C shows schematic diagrams of providing information of POI through an exploration process in the management method according to one embodiment of the disclosure;

FIG. 10A to FIG. 10C shows schematic diagrams describing the exploration process in management method in one further embodiment of the disclosure;

FIG. 11A to FIG. 11B show schematic diagrams describing a process for actively notifying a user of the POI with reward in the method for managing media content for POI according to one embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

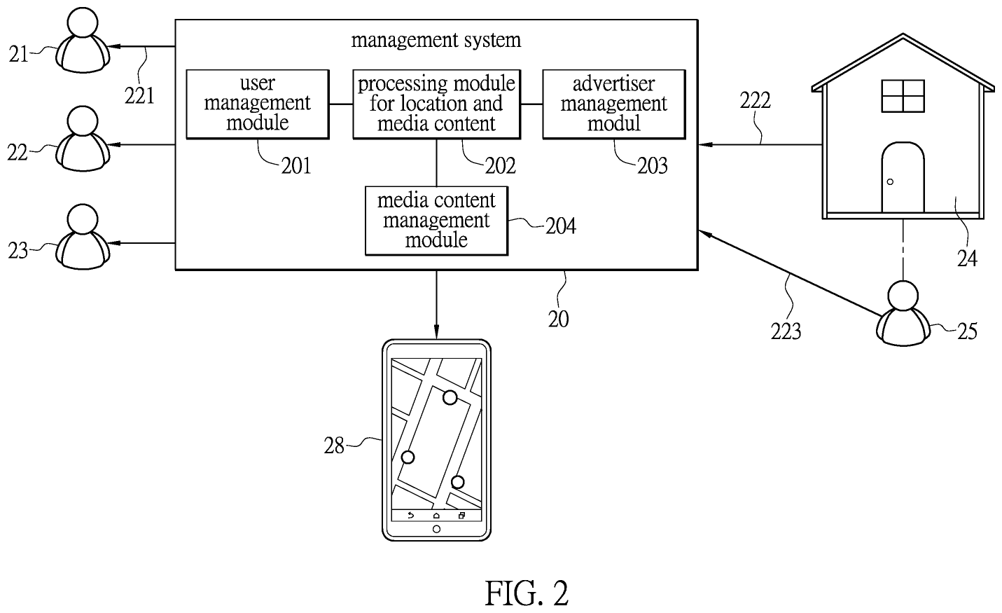

An advertiser may be an owner of a physical store who submits an advertisement to specific network media for attracting people to click the advertisement and visit a web site or to get further information of the store. A visit rate counted by clicks (click through rate, CTR) of the website is referred to, to calculate the advertisement fee. However, it is difficult for the advertiser to evaluate the performance of the advertisement. Provided herein is a system for managing media content for Point of interest (POI) that allows the advertiser to know which users come to the store. The visitors may further be the customers of the store. An aspect of the system for managing media content for POI can be referred to in a schematic diagram of a system framework shown in FIG. 2.

This figure shows a computer-implemented system for managing media content for POI 20. The system 20 includes a server that includes one or more processors for performing a method for managing media content for POI. The functionalities operated in a software process can respectively be embodied by a user management module 201, a processing module for location and media content 202, an advertiser management module 203 and a media content management module 204.

The user management module 201 is used to manage users of the management system 20. The user registers in the management system via a software program installed in a user device. The software program allows the user device to communicate with the management system, e.g. transmitting positioning data and acquiring information of POI from the management system.

A physical store 24 is also shown in the diagram. The store owner becomes an advertiser who submits advertisement to the management system 20. The advertiser management module 203 renders an advertisement setting page for the advertiser to set up the advertisement, including a type, content, a time to advertise, and target users with respect to the advertisement. The system 20 may require the advertiser to set up a condition for rewarding the users. An advertisement 222 is then submitted to the system for managing media content for POI 20. The management system 20 includes a database (not shown in the diagram) that links to the computer-implemented server. The database records a plurality of POIs set by multiple advertisers. The information of POI includes a POI name, a POI location, an advertising time, a target user condition and a reward criterion.

Users 21, 22, 23 and 25 at different locations are shown in the diagram. The users 21, 22, 23 and 25 may become the users of the management system 20. When the user management module 201 verifies a user, the user receives a request for media from the system. The information regarding the reward for the POI may be transmitted to the user device. The users 21, 22, 23 and 25 are invited to come to the POI location regarding the physical store 24 set by the advertiser for creating a media content. The media content is uploaded and the user can be rewarded.

In the present example, the user 25 arrives at the physical store 24, and a media content is created according to a reward criterion. For example, the media content is such as a video about the physical store 24, photos and video inside the store 24, or a description of the store 24. The media content 223 is then uploaded to the management system 20. The processing module for location and media content 202 is then applied to process the media content 223 uploaded by the user 25. In an exemplary example, the processing module 202 retrieves an uploading location of the media, and determines whether or not the media content meets the reward criterion according to the location of the physical store 24. The advertiser can then verify if the media content meets the reward criterion, and the management system 20 can still analyze the media content by the processing module 202 automatically. The processing module 202 retrieves features of images, texts and/or sounds from the media content. The features of media content are used to compare the feature regarding the physical store 24 for verifying if the media content matches the reward criterion regarding the physical store 24.

After confirming that the media content meets the reward criterion, the management system 20 utilizes the user management module 201 to reward the user 25. The reward is recorded to a corresponding user account, or sent to the user as a discount for goods or services. The media content management module 204 then creates a media content link associated to the POI of a physical store 24. The media content becomes a content 28 that can be displayed on a user device. The media content with the media content link can be searched, browsed and be obtainable POI information for others.

It is worth noting that the mentioned rewards for POIs are used to encourage and reward the user who creates a media content at a POI and uploads the media to the system. The media content can be any or a combination of a text, a sound, an image and a video. The system provides a substantial reward such as an advertisement reward to the user who reaches the reward criterion. The advertisement reward is provided by the advertiser who pays a fee for advertising when submitting the advertisement at the POI. The system for managing media content for POI divides a portion of the advertisement fee to the user who reaches the reward criterion. The reward is not limited to any specific type. The reward is provided to users who upload media content as a shared benefit for advertising. For example, a virtual currency can be provided by the system or a platform for the users to purchase goods or services as real money. Further, the reward can also be transferred to the user's financial account. The discount for goods or services is such as a discount in the advertiser's physical store. The reward is set based on the advertiser or user's preference.

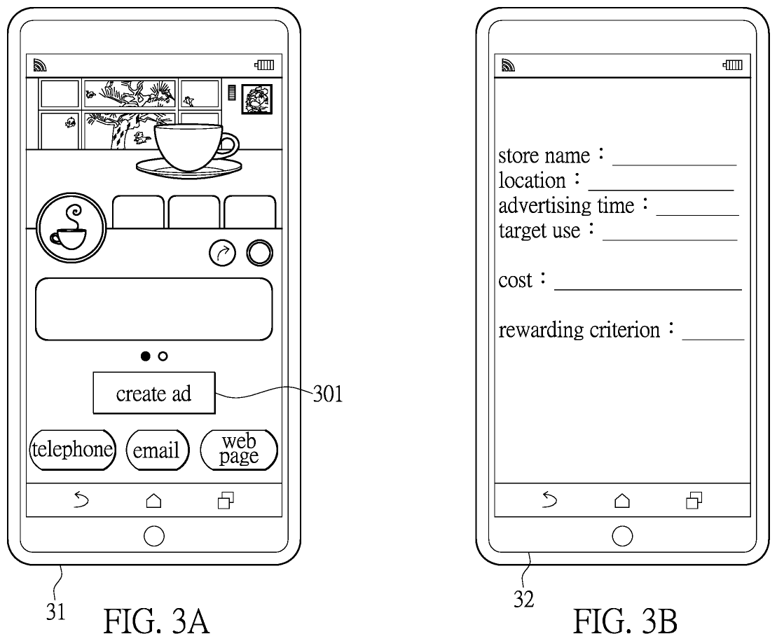

The advertiser uses a software program installed in a computer to link to the system for managing media content for POI for setting advertisement. Reference is made to FIGS. 3A and 3B that schematically show the user interfaces provided for the advertiser to advertise according to one embodiment of disclosure.

FIG. 3A shows a schematic view of a user device on a company page 31. The company page 31 acts as a main page for the advertiser who represents a physical store. The company page 31 is provided for the advertiser to create an advertisement when clicking a button 301 to enter an advertisement setting page.

FIG. 3B shows a schematic view of an advertisement setting page 32. This advertisement setting page 32 is a page for setting the reward criterion for arriving at the store. For example, the page requires the advertiser to input a name for the physical store that acts as the POI. The name is exemplarily for the user to identify the POI. The page also requires the advertiser to set up a location of POI. The location of POI can be set through an electronic map and the corresponding latitude and longitude can be obtained. The location is used to mark the POI. The page asks the advertiser to set up an advertising time that indicates a period of time to show the advertisement. The advertising time can be the time to prompt the user that the POI is with reward. The advertising time is configured to have a start time and an end time. The advertising time can be a daily time for rewarding through the advertisement, and the daily time can be during opening hours of the physical store. The opening hours can be set, but not limited to, as certain days of the week from Monday to Sunday.

Attributes of the target users creating media content at the physical store can be set through the advertisement setting page 32. While there may not be any restriction to target users, restrictive conditions such as any or a combination of gender, a range of location, an age, or a number of followers of the user at the POI accumulated in the system for managing media content for POI may also be set by the advertiser. It should be noted that the cumulative number of followers is referred to as the user's influence.

A cost field of the advertisement setting page 32 can automatically show the cost of advertisement when the advertiser submits his requirements. Alternatively, the page 32 also allows the advertiser to autonomously set a certain amount of payment to advertising, which relates to limitations of advertising time, and click through rate with respect to the advertisement for each day, each period of time or a full time.

The advertisement setting page 32 allows the advertiser to set up a reward criterion to regulate how the users can be rewarded. The reward criterion is a threshold for rewarding set by the advertiser. The criterion is such as a location, a time, content and/or an action for creating the media. The criterion also requires the user to take a picture or video including the appearance of the physical store, inside the store, or conduct an action such as tasting food samples, experiencing a product, or taking a picture with the store clerk. As an example of taking a video, the reward criterion can be set to the location content, length and time of the video. It should be noted that the location and the time to create the media are generally one of main factors to determine if the media meets the reward criterion.

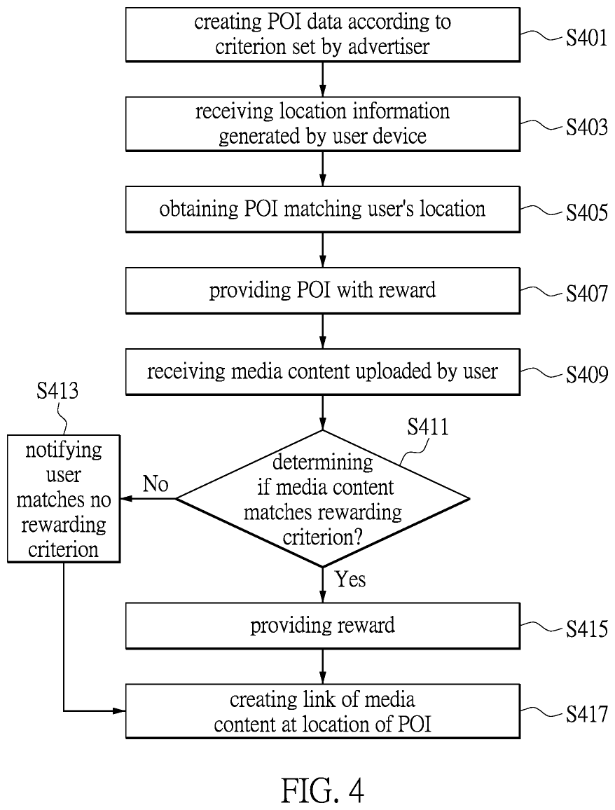

By the cloud-based system for managing media content for POI, a software program is installed in a user device, and the software program is used to communicate with the system. The method operated in the user device is illustrated in FIG. 4.

In the present example, such as in step S401, the system for managing media content for POI establishes a database including data of POIs according to the reward criteria set by advertisers. The reward criterion regulates a requirement to create a media that qualifies for the reward. The reward criterion is such as taking a picture at the entrance of the store or inside the store, and the picture is about tasting the food sample or performing a prescribed action. The advertiser can add further requirements such as in-store purchases, target user and time.

When the management system is in operation, such as in step S403, a software process operated in a server of the system continuously communicates and exchanges data with a software process running in the user device. The system constantly receives the positioning data generated by the user device. A user ID and GPS of the device are included in the data sent to the system. Further, the positioning data received by the system can also be the location where the user searches by using an electronic map, or a store page with reward that the user freely browses. The software program operated in the system obtains the positioning data with respect to the store according to POI.

When the system obtains the positioning data generated by the user device, such as in step S405, the system continuously queries the database to find out the POIs that matches the positioning data. In one further embodiment, the advertiser can find the users who match the conditions according to POI location, the target user, and time through the management system. In step S407, the system filters out the users that match the target user condition, and transmits information of the POIs with reward. Thus, the system can proactively send an invitation message to one or more users to acquire rewards at the POIs.

Further, the user may obtain one or more POIs with reward according to his positioning data at the same time. In the meantime, the system may provide an option for the user to choose which POI to proceed to for the reward. Alternatively, the system may actively provide a sorting of the POIs with reward to the user matching the target user condition, to then transmit the information of a POI with reward selected by the target user to the target user.

In step S409, the user arrives at the POI and creates a media using his user device. The media is uploaded to the system. When the system receives the media from the user, in step S411, the system verifies if the media meets the reward criterion. If the media does not meet the reward criterion, e.g. the location error or content mismatching, the system notifies the user that the media does not meet the reward criterion (step S413). In one embodiment, the completed media can still be uploaded to the management system and associated with a link at a POI even if it does not meet the reward criterion (step S417). The location where the media is created and uploaded can still be a POI. On the contrary, the system provides a corresponding reward (step S415) if the system verifies that the media meets the reward criterion. The type and content of reward can be based on settings in the system set by the advertiser. Similarly, the system creates a media content link associated to the POI (step S417).

No matter whether or not the media uploaded from the user meets the reward criterion corresponding to the POI, the media can still be a link on the map. The links on the electronic map are provided for others to explore, browse and show the media content with respect to the POIs.

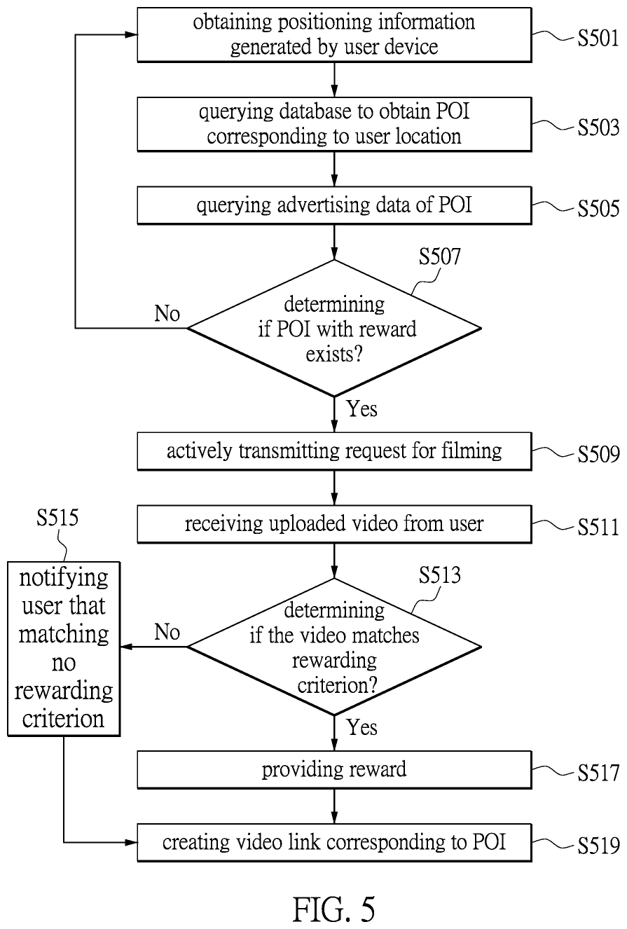

Reference is made to FIG. 5, which shows a flow chart describing the method for managing the media content for POI. The process in the flow chart describes that the user can be notified of the nearby POIs with reward according to his location.

In the beginning, such as in step S501, the system receives positioning data generated by a positioning circuit, e.g. GPS circuitry, of a user device. In step S503, the software program running in the system queries the database according to the positioning data so as to get the POIs corresponding to the user's location. In step S505, the system queries the data of advertisement with respect to POIs in the database for confirming the conditions such as the time, time limit and target user for advertising. After that, the system determines whether or not any POI with reward exists according to a querying result (step S507).

If the querying result shows that no POI with reward exists in the database, the system will not provide any information about the POI with reward but can still show the information of the general POIs. The process then goes to the beginning step S501.

On the contrary, if the querying result shows any POI with reward matching the positioning data generated by the user device, the system will actively transmit the POIs with reward to the user device (step S509). Furthermore, a request inviting the user to shoot a video is sent to the users who match the target user conditions with respect to the POI due to the advertisement. The POI location and a reward criterion with respect to the POI with reward are provided for the user while sending an invitation message to a user device.

When the user receives the information of POI with reward accompanied with the invitation message, the user arrives at the POI and creates a media, e.g. making a video, according to a reward criterion. In step S511, the media is uploaded to a server of the system. The server receives the video, and a software program running in the server is used to retrieve information such as a location, a length, and features of content from the video (step S513). The information allows the system to verify if the video meets the reward criterion.

If the video does not meet the reward criterion, such as in step S515, the system notifies the user that the video does not meet the criterion. The system can still create a link associated to a location (step S5190). On the contrary, if the video meets the reward criterion after analyzing its information, such as in step S517, the system provides a reward that is calculated according to the advertiser's advertising fee. Similarly, in step S519, a link associated with this video can also be created at the POI.

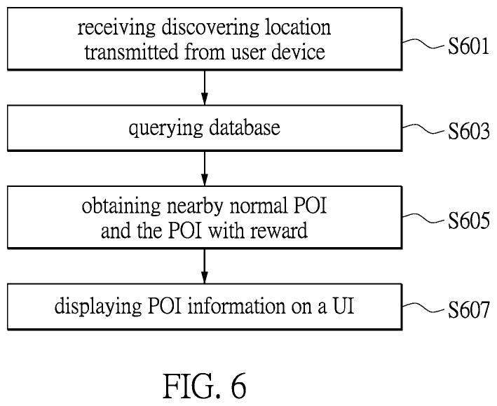

FIG. 6 shows another flow chart describing the method for managing media content for POI in another embodiment of the disclosure.

In the present embodiment, a user manipulates a user device to explore an area or search with some specific keywords. While exploring the area, positioning data relating to the area is generated. In step S601, the system receives the exploration data uploaded from the user device. The exploration data corresponds to an area that can be a display area shown on the user device. The area may be changed in response to the user's manipulation, e.g. zoom in or zoom out. When the system receives the positioning data based on the change, such as in step S603, one or more POIs can be obtained by querying a database according to the positioning data. The one or more POIs within the area are displayed on the user device, and the POI with reward will be labeled on the electronic map.

At the same time, such as in step S605, general POIs and the POIs with reward can be recognized within these POIs. In step S607, the information of POI can be shown through a user interface, e.g. an electronic map or a list menu, which is provided for the user to choose one or more POIs. The information of POI can be shown by a user interface. For example, the POIs with reward can be marked on the electronic map or listed on a menu that is provided for the user to acknowledge the information of POI.

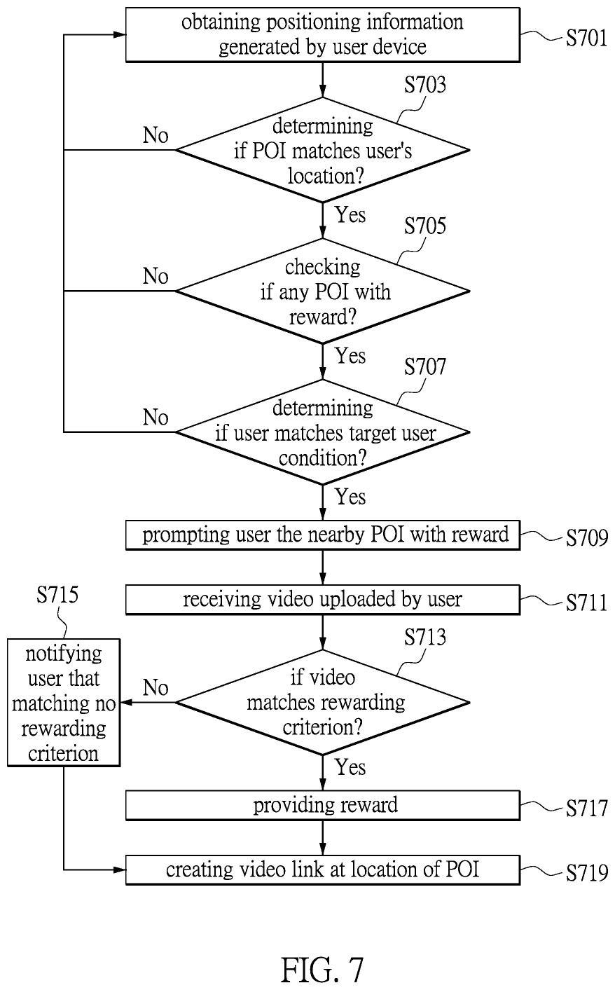

In one further embodiment shown in FIG. 7, the system provides a proprietary software program executed in the user device that is carried by the user. The positioning circuit of the user device continuously generates the positioning data, and the system constantly receives said positioning data (step S701). The system can identify the user in the process to determine whether the user matches target user conditions, and can query the database according to the received data to determine whether or not any POI matches the user's location (step S703).

In the software process, if the system finds no POI near the user within a geographical range set by the user or the system, the process will repeat the above-mentioned steps S701 and S703 until a nearby POI is found.

If any nearby POI is found, the system allows the user to choose one or more POIs within the geographical range. In step S705, the software program running in the system checks if any POI with reward exists within the geographical range.

If no POI with reward is found within the geographical range after querying the database, the process goes to step S701 and repeats the mentioned steps. On the contrary, if at least one POI with reward within the range is found, the process goes to step S707 for determining whether or not the user is qualified to get the POI with reward. This step is used to check if the user matches the target user condition associated with the POIs.

If the system confirms that the user is the target user of one of the POIs, an icon or a specific mark is used to label the one or more POIs with reward to the user (step S709). Therefore, the user can choose one or more POIs in which he is interested. After the user chooses one of the POIs, the system provides the information of POI and the information will be shown on a page.

In step S707, if no POI with reward is matched with the user, the system may provide only the normal POIs registered in the system and repeat the steps S701, S703 and S705.

In one embodiment, such as in step S709, the software program running in the user device receives the information regarding the nearby POIs with reward from the system. For example, a symbol can be shown on a page for prompting that a certain location contains a POI with reward. Alternatively, the user can be prompted by vibration or sound activated by the software program. If multiple POIs with reward corresponding to the positioning data are found, a selection menu can be provided for the user to make a selection.

After that, in step S711, the user can select one of the POIs and get the information, e.g. of the reward criterion. The user then arrives at the POI, shoots a video regarding the POI, and uploads the video to the system. The software process running in the system determines if the video uploaded from the user device meets a reward criterion associated with the POI after receiving the video (step S713).

If the video does not meet the reward criterion, the process goes to step S715 for notifying the user that the video is not qualified to get the reward. Similarly, such as in step S719, a link associated with the video can still be created on the electronic map. If the video meets the reward criterion, a reward is provided after confirmation (step S717). A link associated with the video is created at the POI (step S719).

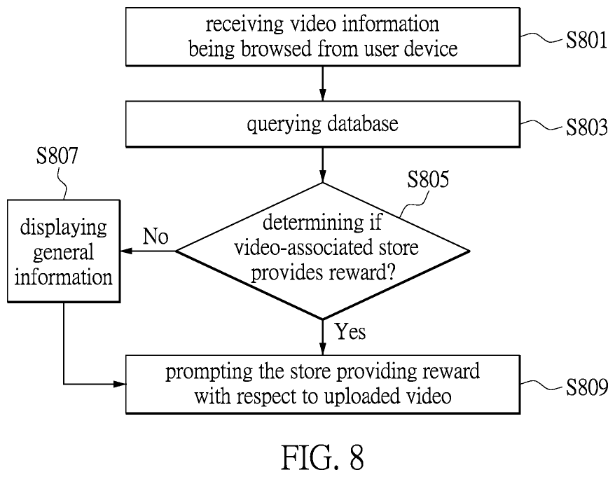

Referring to a flow chart shown in FIG. 8 according to one embodiment of the disclosure, the user can be prompted to check the POIs with reward when he browses the store pages using a browser program. In step S801, the system receives information while browsing the video associated with the POI by the user device via a network. The system will reply with POI information such as the location of POI. The system then queries the database (step S803) according to the location of POI, and determines whether or not the store corresponding to the video provides a reward to the user (step S805).

If the POI does not provide a reward, the process goes to step S807 for showing general information of the POI. If the POI provides the reward, such as in step S809, the system prompts the user that the store corresponding to the video, i.e., the store providing the advertisement, offers the reward for the user who uploads a video about the store.

The system receives an instruction to select a POI when the user manipulates the user device to browse the stores and make a selection. The POI location is sent to the system. The system shows a POI page via the user device. If the POI is applied with a reward criterion, the POI page shows a reward prompting icon and other media content associated with the POI.

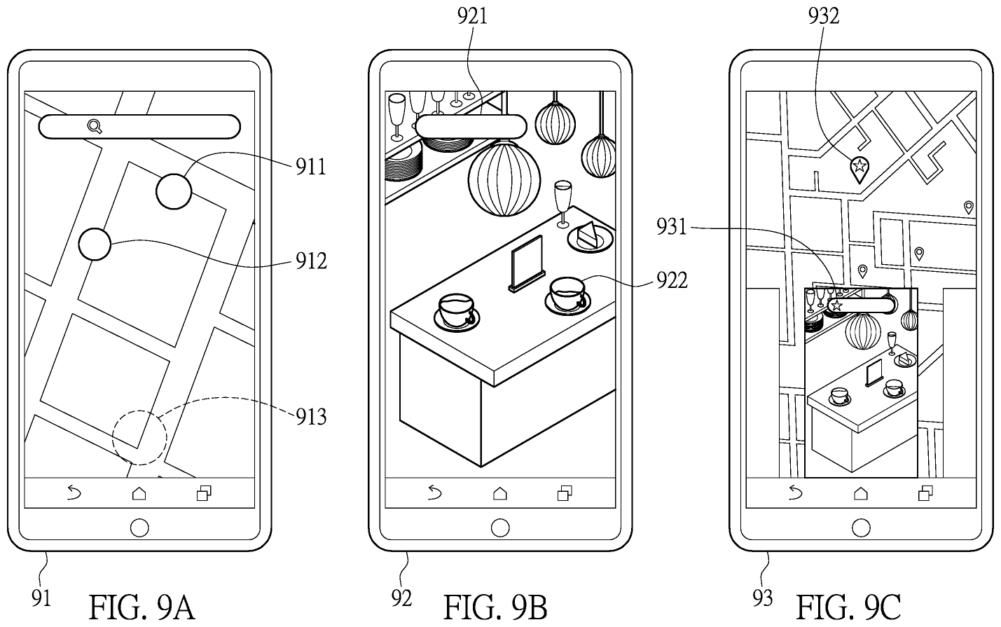

Next, FIGS. 9A through 9C show schematic diagrams depicting exploration scenarios of POIs in the management method operated in a user device according to one embodiment of the disclosure.

FIG. 9A shows a POI exploration page 91. Two POIs 911 and 912 are shown in the electronic map. The POIs 911 and 912 are obtained by querying the database according to positioning data transmitted by the user device. A shooting button 913 is provided on this page to allow the user to film immediately.

FIG. 9B shows a POI page 92. The POI page 92 schematically shows an image of a physical store associated with the POI that is selected by the user. The image represents the media content 922, e.g. a video, associated with the POI. If this POI provides a reward, a reward prompting icon 921 can be used to prompt the user to get the reward at the POI.

FIG. 9C shows a ready-to-shoot page 93 that is provided for the user ready to take a picture or video when the user arrives at the POI. This POI 932 prompts the user that a reward is provided here. In the meantime, the user can immediately take a picture by clicking the shooting button 931.

The present page that allows the user to take the picture or video can be initiated by the user himself or automatically by a program running in the user device. The program continuously checks if the positioning data generated by the user device matches the location of POI. The program can initiate the ready-to-shoot page 93 automatically when the positioning data matches a POI. Therefore, the user can be notified that there is at least one nearby POI with reward by the program executed by the user device even when the user has not planned on going to any POI.

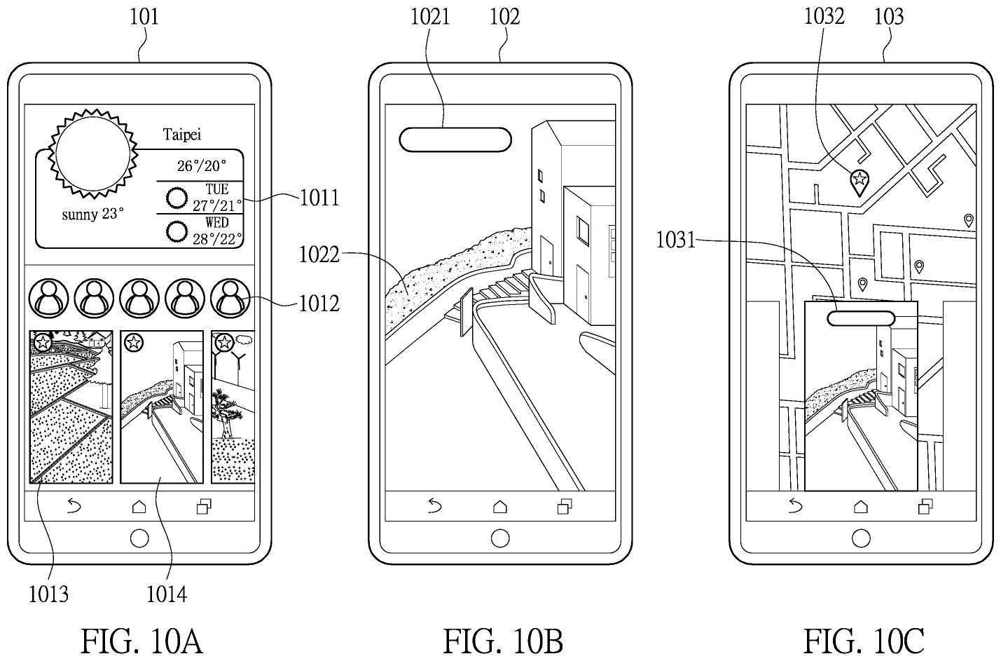

FIGS. 10A through 10C show the schematic diagrams depicting the system providing information of a POI that is explored by the user in the management method according to one embodiment of the disclosure.

FIG. 10A shows that a user uses a program to explore POIs that are not necessarily near the user. A POI exploring page 101 is shown in the diagram. The POI exploring page 101 shows weather information 1011 and related user links 1012 about the POI. The users with the user links 1012 are users that have already created the media content relating to the POI. The page 101 also prompts the user that there are POIs (1013, 1014) with reward nearby if the POIs provide reward.

When the user chooses one of the POIs, a POI page 102 is shown as FIG. 10B. The POI page 102 shows the media content 1022 of the POI, and also prompts that the POI provides reward by a reward prompting icon 1021.

FIG. 10C further shows a ready-to-shoot page 103 that allows the user to shoot a video via a POI shooting button 1031 when the user arrives at the POI 1032.

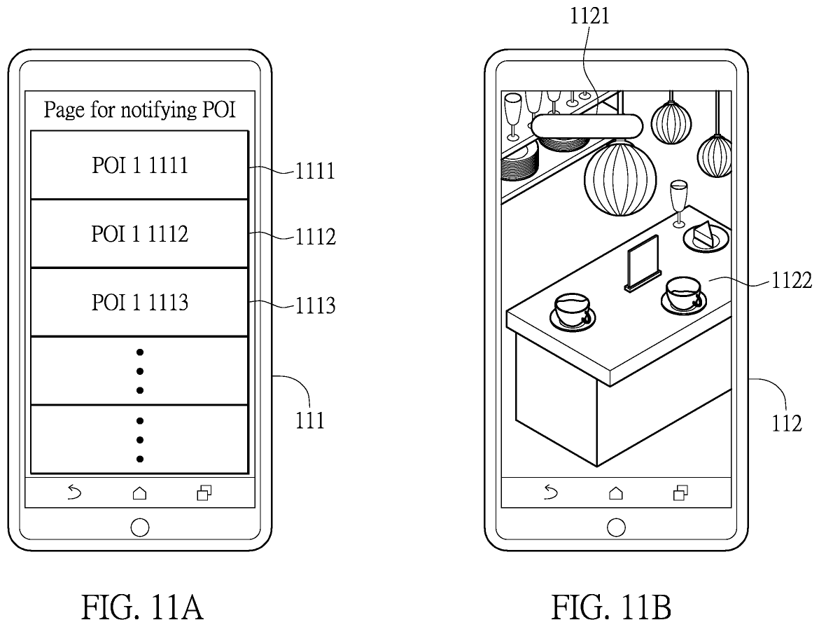

FIGS. 11A and 11B show schematic diagrams depicting the system notifying the user of the POIs with reward in the management method.

FIG. 11A shows a POI notification page 111. When the user carrying a user device arrives at a place, the software program running in the user device transmits positioning data to the user automatically. The present example shows multiple POIs including POI 1 (1111), POI 2 (1112) and POI 3 (1113) with reward when the system queries the database to obtain the nearby POIs with reward.

FIG. 11B shows a POI page 112 that depicts an image when the user clicks one of the nearby POIs with reward. The POI page 112 shows the information such as the media content 1122 relating to the POI. A reward prompting icon 1121 is provided to prompt the POI with reward.

To sum up, based on the above embodiments of the method for managing media content for POI, the system allows an advertiser to set up an advertising criterion that requires the user to arrive at the physical store or a place for the purpose of achieving effective advertisement. The advertising criterion renders a new advertisement aspect that provides a motivation for users to proceed to the store or place to get the reward.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for managing media content for POI (Point Of Interest), operated in a server of a system for managing media content for POI, comprising:
the server receiving a positioning data generated by a user device via a network;
in the server, querying a database to obtain one or more POIs corresponding to the positioning data;
providing information including a POI location of each POI with reward by the user device if one or more POIs with reward corresponding to the positioning data is found;
the server receiving media content from the user device; and
providing a reward if the media content is verified to match a reward criterion based on a location where the media content is created.

2. The method as recited in claim 1, wherein the positioning data is generated when the user device is used to search POIs within a range via an electronic map.

3. The method as recited in claim 2, wherein the one or more POIs within the range is displayed by the user device, and any POI with reward will be labeled on the electronic map.

4. The method as recited in claim 3, wherein, when one POI with reward is selected by the user device, a POI page with a reward prompting icon and POI media content is displayed.

5. The method as recited in claim 1, wherein a positioning circuit of the user device generates the positioning data when the user device is at a location.

6. The method as recited in claim 5, wherein, when any POI with reward is found by querying the database according to the positioning data, an invitation message is proactively transmitted to the user device, and the POI location and the reward criterion of the POI with reward are provided.

7. The method as recited in claim 6, wherein a selection page showing an option with multiple POIs is provided if multiple POIs with rewards corresponding to the positioning data are found.

8. The method as recited in claim 7, wherein, when one of the POIs is selected by the user device, the POI location corresponds to the positioning data.

9. The method as recited in claim 1, wherein, when the user device is used to browse a plurality of POIs, the server queries the database for providing data of each POI; when one of the POIs is selected, the POI location corresponds to the positioning data.

10. The method as recited in claim 1, wherein, if it is verified that the media content matches the reward criterion, a media content link corresponding to the POI location is created in the server.

11. The method as recited in claim 1, wherein an advertiser sets up the POI with reward through an advertisement setting page provided by the server, and the POI with reward includes a POI name, the POI location, an advertising time, a target user condition and the reward criterion.

12. The method as recited in claim 11, wherein the advertising time indicates a time for prompting the POI with reward via the user device.

13. The method as recited in claim 11, wherein the target user condition is a filter set by the advertiser for filtering the users who are able to obtain the reward, the target user condition is one or any combination of selected from the user's gender, location, age and a tracking number with respect to the user.

14. The method as recited in claim 11, wherein the reward criterion is a threshold set by the advertiser for filtering the users to obtain the reward, the reward criterion is one or any combination of a location and a time for creating the media content, video content and an action.

15. A system for managing media content for POI, comprising:
a server, by one or more processors of the server, performing a method for managing media content for POI; and
a database, associated with the server, recording a plurality of POIs set up by a plurality of advertisers, and a POI name, a POI location, an advertising time, a target user condition and a reward criterion with respect to each of the POIs;
wherein the management method includes:
receiving a positioning data generated by a user device via a network;
querying the database for obtaining one or more POIs corresponding to the positioning data;
providing information including a POI location of each POI with reward by the user device if one or more POIs with reward corresponding to the positioning data is found;
receiving media content from the user device; and
providing a reward if the media content is verified that it matches a reward criterion based on a location where the media content has been created.

16. The system as recited in claim 15, wherein, in the management method, the positioning data is generated when the user device is used to search POIs within a range via an electronic map, and one or more POIs within the range is displayed by the user device, and any POI with reward will be labeled on the electronic map.

17. The system as recited in claim 15, wherein, in the management method, when the user device is at a location, a positioning circuit of the user device generates the positioning data; when any POI with reward corresponding to the positioning data is found by querying the database according to the positioning data, an invitation message is proactively transmitted to the user device, and the POI location and the reward criterion with respect to the POI with reward are also provided.

18. The system as recited in claim 15, wherein, when multiple POIs are browsed by the user device, information for each of the POIs is provided by querying the database; the POI location corresponds to the positioning data when one of the POIs is selected.

19. The system as recited in claim 15, wherein, in the management method, when it is verified that the media content matches the reward criterion, a media content link corresponding to the POI location is created in the server.

20. The system as recited in claim 15, wherein, if the positioning data corresponds to multiple POIs with reward, an option with multiple POIs is provided.

21. The system as recited in claim 20, wherein the target user condition is a filter set by the advertiser for filtering the users who are able to obtain the reward, the target user condition is one or any combination of the user's gender, location, age and a tracking number with respect to the user.

22. The system as recited in claim 20, wherein the reward criterion is a threshold set by the advertiser for filtering the users to obtain the reward, the reward criterion is one or any combination of a location and a time for creating the media content, video content and an action.
